(19) United States
(12) Patent Application Publication
(10) Pub. No.: US 2015/0075389 A1
(43) Pub. Date: Mar. 19, 2015

(54) SKEWER MACHINE FOR CONTINUOUSLY PRODUCING FOOD ON SKEWERS

(71) Applicant: Nicolino VITILEIA, COLLECORVINO (PE) (IT)

(72) Inventor: Nicolino Vitileia, Collecorvino (PE) (IT)

(21) Appl. No.: 14/390,435

(22) PCT Filed: Apr. 10, 2013
(86) PCT No.: PCT/IT2013/000103

§ 371 Date: Oct. 3, 2014

(30) Foreign Application Priority Data
Apr. 12, 2012 (IT) RM2012A000155

(51) Int. Cl. A22C 17/00

(52) U.S. Cl. CPC A22C 17/0066
USPC 99/421 R

(57) ABSTRACT

A skewering machine for producing food on skewers, of the type that uses a plurality of containers/trays provided with cells according to the pieces of food to be skewered, wherein skewering is obtained by pre-piercing the food pieces with steel needles, envisages that, after pre-piercing, skewering of the food pieces with each skewer is obtained in synchronism with extraction of the respective pre-piercing needle such that advance of the skewer in the food pieces is constantly guided in the hole left by the corresponding needle; the pre-piercing of the food pieces and the arrangement thereof on the skewers being obtained by continuous movement elements without interrupting the motion of the containers/trays. Skewering of the food pieces is obtained with continuous motion via a plurality of pre-piercing moving elements and of respective thrust moving elements, the moving elements being set in a revolver-type arrangement on at least one rotary drum.

The subject of the invention is a skewering machine, i.e., a machine for the production of foodstuffs cut into pieces or having small dimensions, arranged on skewers, by which they are held together.

This type of foodstuffs, known more commonly as “sack-on-skewer”, or, if roasted, as “arrosticini”, “shish kebab”, “kepab” or “kebab”, “churrasco”, “souvlaki”, etc., is widespread in many culinary traditions of the world.

The pieces of food used are in general red and white meat, fish, vegetables or fruit, as well as foodstuff products already prepared, such as wurstel, sausages, etc.

Preparation of the product is particularly laborious, irrespective of the pieces of food used, in so far as it envisages, in a first step, preparation of the piece/pieces of food required, possibly cutting them into portions, and then, in a second step, manual arrangement of the pieces on the skewers, possibly alternating the layers of the various pieces of food according to the recipe chosen.

The laboriousness of these operations has oriented several manufacturers to the production of machines that are able to facilitate and/or carry out the mechanical operations of skewering.

The document No. US 2009/181155 describes a machine for kebabs for automatically inserting wooden skewers in various foodstuff components, such as for example meat, vegetables, and the like. The foodstuff components are kept inside the conveyors, whereas the individual skewers are conveyed by a skewer conveyor. The skewers are guided through the conveyors and the foodstuff components present therein to form the kebab. As the conveyors are passing over a gear wheel, the adjacent carrying elements tilt with respect to one another with tiltable elongated extensions until they release and expel the skewers with the pieces of food arranged thereon from the conveyors for further processing operations.

The document No. WO 2009/025082 envisages a skewering apparatus that is able to insert a skewer directly in materials placed on a tray so that it can perform a skewering operation in the same manner as when skewering by hand. A tray carrying materials is transferred to a skewering position, and the materials placed on the arraying unit of the tray are then held by the holding unit of a holding device. A circular skewer, which is drawn starting from the guiding passage of a loading unit of a driving device, is inserted straight into the centre of the materials arranged in a line in the arraying unit.

The document No. NL 1035785 describes a device provided with a container having a compartment for withholding the pieces of food, where the dimensions of the compartment are aligned for maintaining in position the pieces of food. A driving unit is arranged on a support, and the compartment is designed for blocking the pieces of food.

The document No. FR2929079 describes a machine that has a supporting base comprising a guard for protection of the guiding unit. The base and the guard enable sliding of a mould-supporting unit, the mould comprising housings for cubes of food and grooves for passage of the skewers for skewering the cubes of food.

The above machines are based upon the use of particular containers or trays bearing a succession of housings or cells, having the shape and set in the order chosen by the manufacturer.

Each cell will have the shape of the product that it is designed to receive, i.e., of the piece of meat, vegetable, sausage, etc.

To speed up the operations of filling, the trays are mounted on a conveyor, or on other movement systems, in such a way that, with a certain cadence, the operator is presented, in succession, with empty trays to be filled.

However, the skewers produced mechanically with the methods referred to above present a series of disadvantages and problems, above all regarding the efficiency and reliability of the machines themselves.

The main purpose of the invention is hence to overcome said disadvantages by providing a machine presenting greater efficiency, reliability, and productivity as compared to the machines currently on the market.

The above purpose has been obtained, according to the present invention by providing a machine presenting substantial modifications to some functional elements and consequently to the modalities of execution of the steps of the production cycle, as specified in the ensuing claim 1.

A better understanding of the invention will be obtained from the ensuing detailed description with reference to the attached drawings, which illustrate a preferred embodiment thereof purely by way of non-limiting example.

In the drawings:

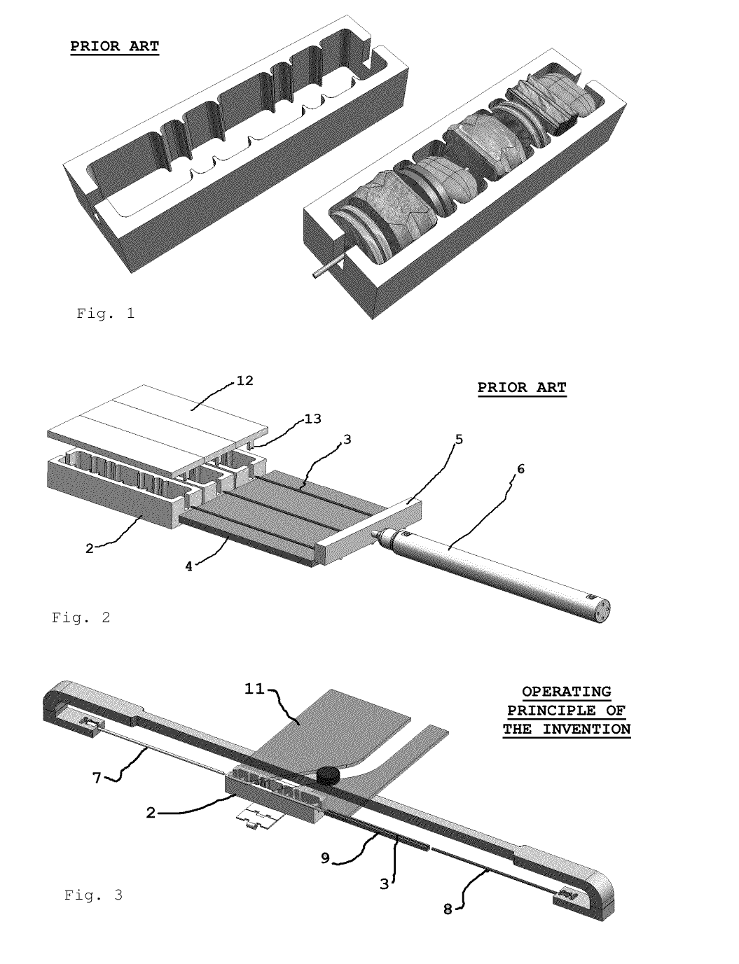

FIG. 1 shows a container/tray of a known type, used in existing skewering machines,

FIG. 2 is a view of the principle used in the machines currently on the market;

FIG. 3 is a view of the principle diagram used in the new skewering system;

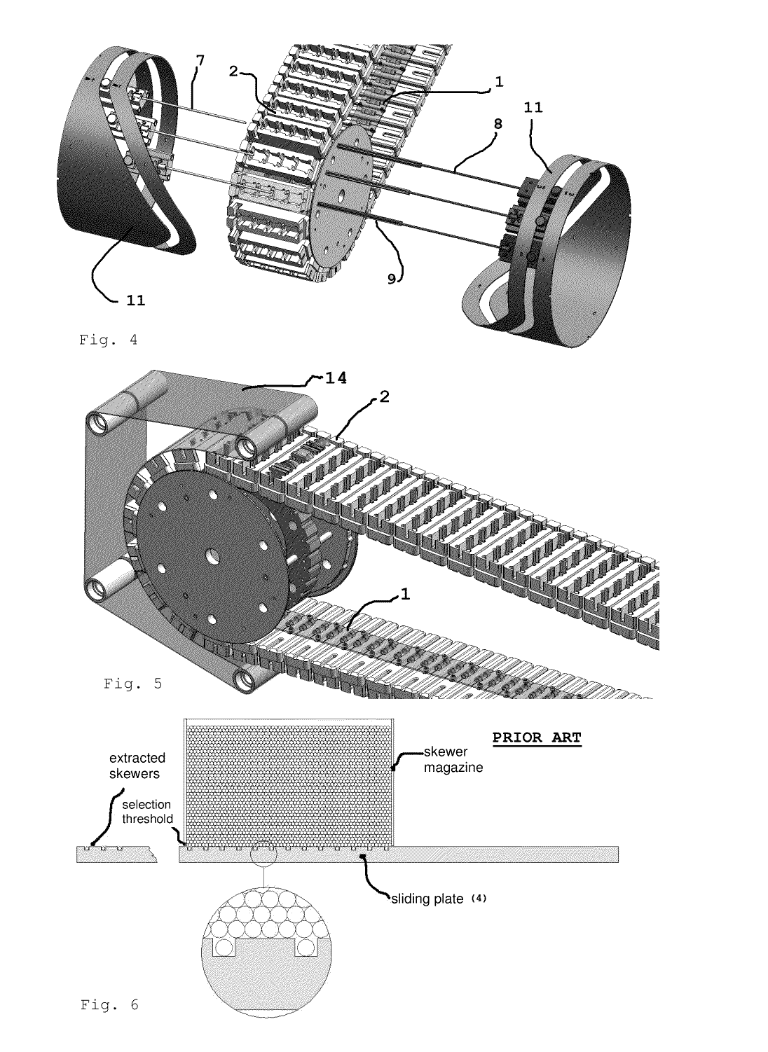

FIG. 4 is a view of the main elements of the new system for arranging the pieces of food on the skewers set in a revolver-type arrangement.

FIG. 5 is a view of the system for closing the containers/trays by means of the new flexible-band system;

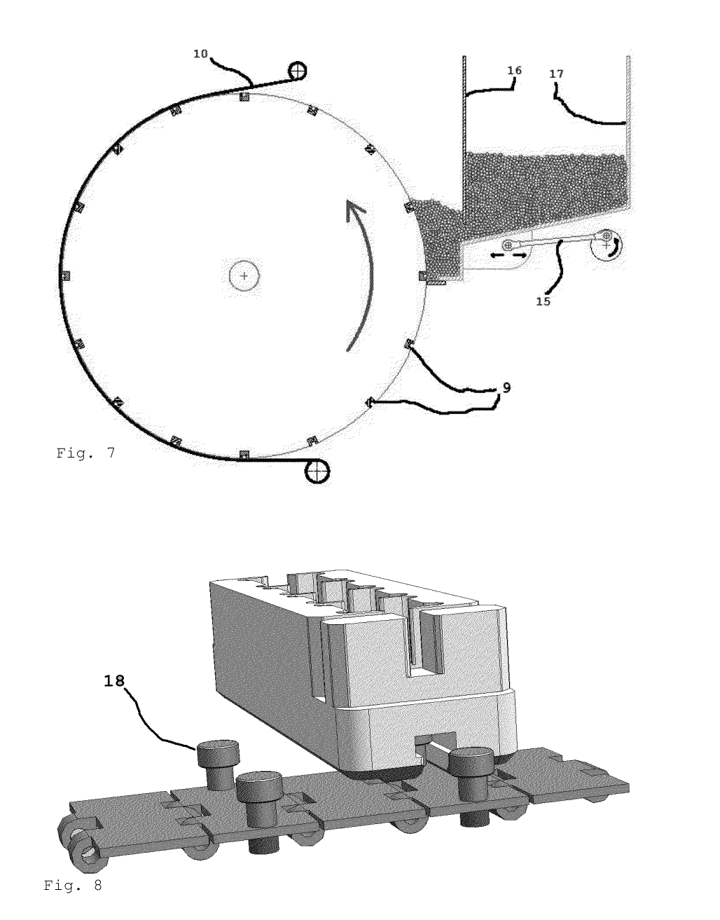

FIG. 6 is a schematic view of the currently known device for selection and automatic loading of the skewers;

FIG. 7 is a schematic view of the new device for selection and automatic loading of the skewers;

FIG. 8 shows the system for fast coupling of the containers/trays to the conveying system;

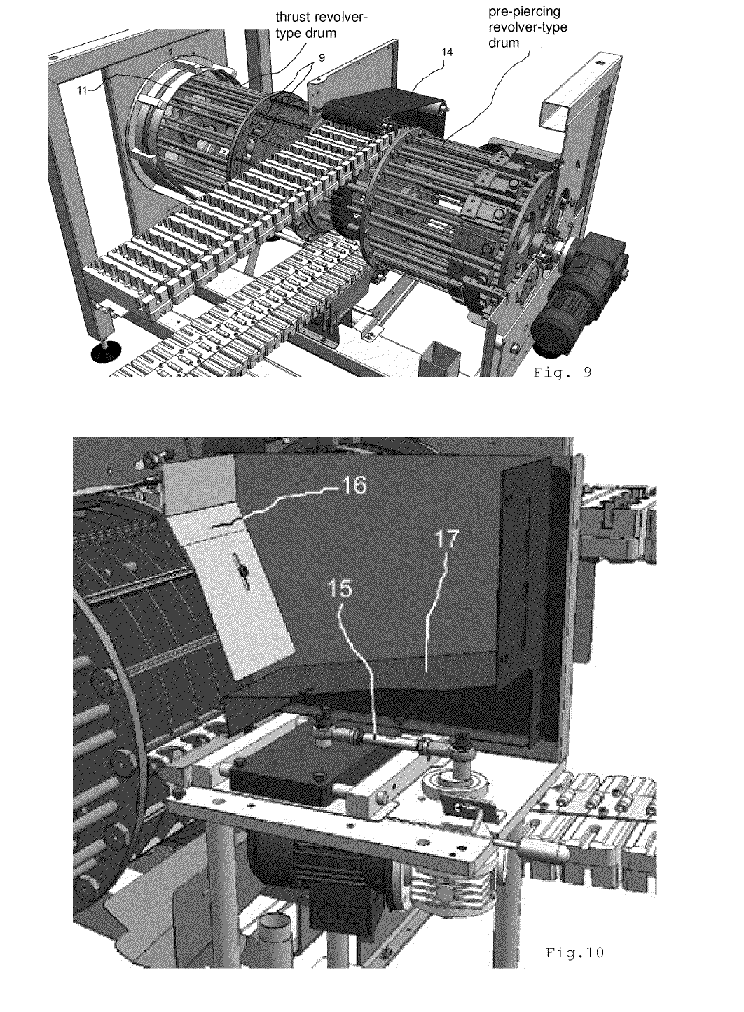

FIG. 9 is a 3D view, from the side opposite to that of FIG. 4, which shows a part of the invention already assembled in the portion for conveying of the food to be skewered and for arrangement thereof on the skewers;

FIG. 10 is a 3D view from the side opposite to the previous one, which illustrates the new system for automatic loading of the skewers; and

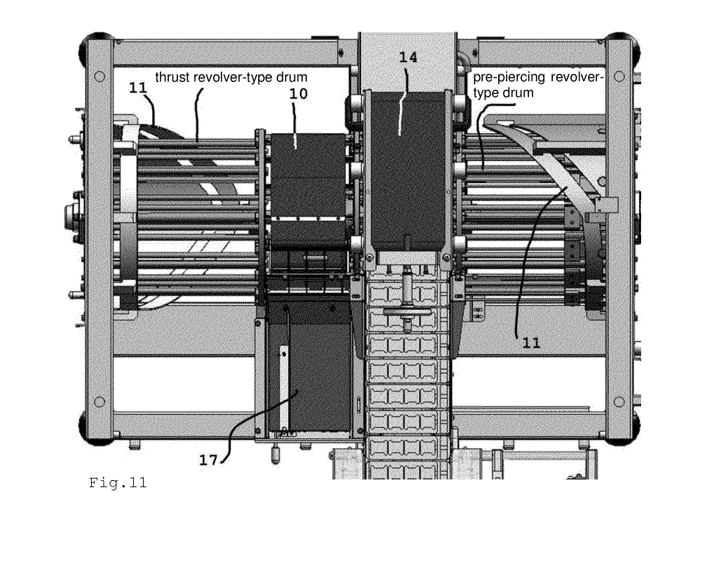

FIG. 11 is a top plan view corresponding to those of FIGS. 9 and 10.

As is will be seen more clearly in what follows, the main improvements introduced by the present invention are:

A. improvements to the skewering system;
B. improvements designed to increase the productivity by providing a continuous skewering cycle without any pause and/or intermittence;
C. improvements to the system for closing the containers/trays;
D. improvements to automatic pick-up of the skewers; and
E. improvements to the system for connection of the containers/trays to the conveyor to enable, in the case of change of format of the product, a fast replacement thereof without dismantling the conveyor.

### A—Improvements to the Skewering System

The machines currently on the market are constituted by a conveyor, fixed on which are the containers/trays, or else by some other system for conveying the containers/trays.

As may be seen in FIG. 2, currently arrangement of the pieces of food on the skewers 3 deposited in the grooves of the sliding plate 4 is obtained by pushing the skewer into the tray and into the product contained therein by means of a pusher 5 actuated by a pneumatic cylinder 6 or some other equivalent system.

Unlike known existing systems, the skewering system of the invention is constituted by:

i) a first moving element comprising a first pointed needle 7, preferably made of stainless steel, designed for pre-piercing the piece of food;
ii) a second moving element comprising a second needle 8, preferably made of stainless steel, designed for pushing the skewer 3 into the piece of food;
iii) means for synchronized movement by cams 11 of the two moving elements referred to in points i) and ii);
iv) means for picking up the skewers 3 from a purposely provided magazine; and
v) means for containing the skewers 3 in the respective housings 9 using a purposely provided flexible band 10, wherein said moving elements, said means for picking up the skewers, and said respective housings for the skewers all move in synchronism with continuous motion corresponding to the movement of the containers/trays for the foodstuff product to be skewered.

It should be noted that by means of said skewering system the following purposes are achieved:

a) Perfect Centring of the Skewer in the Product

The system is such as to guarantee that, during the movement of skewering, the skewer is always guided and accompanied so as to prevent it from coming out of the foodstuff product in the passage between the various cells of the tray or so as to prevent, on account of the variation of consistency of the various products skewered, the skewer from being deviated and coming out of the product to be skewered.

b) Guarantee That the Skewers Won't Stick, Deflect or Break

Simple skewering by pushing the skewer into the piece of food does not prevent, where defects of rectilinearity (skewer bent) are present, the skewer from possibly sticking in the passage between one cell and another of the tray, or else from possibly deflecting in its path, thus failing to skewer some piece of food or, worse still, from possibly breaking and thus jeopardizing production.

According to a peculiar characteristic of the invention, by subjecting the foodstuff product in advance to an operation of pre-piercing by means of a rigid needle 7 and extracting the needle as the skewer advances in the product, the present invention guarantees that the aforementioned problems and defects will not arise.

Another peculiar characteristic of the invention is represented by the fact that, during arrangement of the foodstuff products on the skewers 3, the latter translate with respect to the band 10 that keeps them within the respective housings 9. Advantageously, the friction that is generated between the skewers 3 and the band 10, which holds them in the housings 9 during the skewering process, causes a rotation of each skewer in its housing, achieving a substantial effect of self-centring even in the case where the skewers are slightly bent.

For this purpose, the skewers 3 project slightly in a radial direction from the respective housings 9 so as to be always in contact with the band 10 that turns them.

B. Improvements Designed to Increase Productivity By Providing a Continuous Skewering Cycle Without Any Pause and/or Intermittence

The machines currently available on the market are constituted by a conveyor on which the containers/trays are fixed. Skewering is obtained as a rule in the following way:

The conveyor advances in steps (i.e., in a discontinuous way).

In fact, when the tray, after being filled, is in the skewering station, the conveyor stops, the tray is closed mechanically, and the skewer is pushed into the tray by a pneumatic cylinder or some other equivalent system.

Unlike in the known art, the present invention is constituted by a plurality of synchronized piercing and thrust moving elements, set circumferentially in a revolver-type arrangement, where actuation of the pre-piercing needles and of the skewering device is obtained by means of an innovative desmodromic control with cams 11 synchronized with the movement of the conveyor belt.

One of the peculiar characteristics of the present invention lies in the fact that the means for picking up the skewers, the moving elements for perforating foodstuffs and for pushing the skewers, and the trays that contain the foodstuffs to be skewered all move in a synchronized way with continuous motion.

Advance of the conveyor is consequently always continuous in all its parts, there being no dead times between one skewering operation and the next.

Another advantage of the invention is that, unlike the known machines that shoot the skewer into the product in order to reduce to a minimum the times of arrest of the cycle, in the present invention the skewering speed, thanks to the cams of the desmodromic control, is very low, gentle, and progressive, thus guaranteeing of the integrity of the product, which, otherwise, might “explode”.

### C. Improvements to the System for Closing the Containers/Trays

The machines currently available on the market are constituted by a conveyor on which the containers/trays are fixed. Closing of the containers/trays is obtained by means of rigid elements 12 that are set resting and pressed against them (FIG. 2).

Unlike known existing systems, the system for closing the containers/trays according to the present invention is constituted by a continuous belt 14 that moves in synchronism with the conveyor. The belt, pressed on the conveyor, and in particular on the containers/trays that contain the foodstuffs, ensures a delicate grip of the foodstuff product/products, does not require (see FIG. 2) any particular centring 13 between the containers/trays and the lids, and does not require any further motor-drives and/or other drives since it is moved by the friction between the belt and the containers themselves.

### D. Improvements to Automatic Pick-up of the Skewers

In currently known skewering machines (FIG. 6), the skewers are deposited in an orderly way in prismatic containers provided with a mobile bottom constituted by a sliding plate 4 provided with grooves transverse with respect to the direction of the movement of the plate itself, into which the skewers 3 drop by gravity.

In other words, said plate 4 is made to translate with horizontal motion so as to extract only and exclusively the skewers 3 that have remained imprisoned in the grooves.

With the above known systems the following drawbacks arise:

1. Difficulty of arrangement of the food on the skewer 3 in the grooves in the case of poor linearity of the skewer (skewer twisted) or in the case of skewers with diameter out of tolerance. To overcome these problems the tendency is to make the grooves wider than the diameter of the skewer.

2. Possibility, given the greater width of the grooves, of erroneously picking up two skewers housed in one and the same groove or in any case of drawing two of them up to the selection threshold.

3. Frequent jamming of the skewers in the selection threshold: the end wall of the magazine, in the direction of motion of the plate, operates as selector; i.e., it “scrapes away ” from the plate the skewers that are not housed in the grooves. At this point, all the problems due to the imperfections of diameter and of rectilinearity of the skewers are concentrated, creating frequent interruptions and/or requests for intervention for releasing any jamming that arises.

In the case of jamming of the skewer against the selection threshold, if the thrust exerted on the plate is sufficient, there may even occur splintering of the skewer, with the possible entry of splinters of the skewer in the foodstuffs.

To overcome the above drawbacks, the present invention envisages an innovative system for picking up the skewers, where the skewer magazine has a fixed front wall 16, whereas the rest of the magazine 17, provided with an inclined bottom, is mobile with reciprocating horizontal motion produced by a purposely provided crank system 15.

This system enables continuous ordering of the bundled skewers in so far as they are forced, owing to friction between them, to turn on their axes and to set themselves in an orderly way in a plane, without any superposition and/or criss-crossing.

The aforesaid reciprocating horizontal motion moreover generates the thrust for skewering of the food in the respective pick-up housings 9.

### E. Improvements to the System for Connection of the Containers/Trays to the Conveyor to Enable, in the Case of Change of Format of the Product, a Fast Replacement Thereof, Without Dismantling the Conveyor

In the majority of known systems, the containers/trays are constrained in a fixed way on the conveyor so that the operations of replacement thereof, in the case where it were necessary to change the production program, require long operations for dismantling and replacement given the large number of containers/trays normally mounted on the conveyor.

In the present invention, the operation of replacement of the containers/trays is carried out in a fast way and without the use of tools, said containers/trays being constrained to the conveyor by a fast-coupling system 18 of a known type, preferably of a bayonet type or in some other similar way.

1. A skewering machine for producing food on skewers, of the type that uses a plurality of containers/trays (2) for the foodstuff product that are provided with cells according to the pieces of food to be skewered, wherein skewering is obtained by pre-piercing the pieces of food with steel needles (7), said machine being characterized in that it comprises means such that, after pre-piercing, skewering of the pieces of food with each skewer (3) is obtained in synchronism with extraction of the respective pre-piercing needle (7) in such a way that advance of the skewer into the piece of food is constantly guided by the hole left by the corresponding needle; said pre-piercing of the pieces of foods and said skewering thereof being obtained with continuous movement means without interrupting the motion of the containers/trays (2).

2. The machine according to claim 1, characterized in that skewering of the pieces of food is obtained with continuous motion by means of a plurality of purposely provided pre-piercing moving elements and of respective thrust moving elements (8), said moving elements being set in a revolver-type arrangement on at least one rotary drum.

3. The machine according to claim 2, characterized in that said pre-piercing and thrust moving elements are actuated by a system of cams (11) designed to guarantee smooth and continuous movements during rotation of the revolver-type drum.

4. The machine according to claim 3, characterized in that, in addition to insertion of the skewer (3) into the pieces of food guided by the movement of extraction of the pre-piercing needle (7) envisages that, during skewering, the skewers (3) undergo a movement of axial rotation such as to improve advance and self-centring thereof; said rotary movement of the skewers (3) being imposed by means of a purposely provided band (10) designed to keep the skewers (3) in respective housings (9), which are provided on a rotary drum or rotor and with respect to which the skewers project radially to remain always in contact with the band (10).

5. The machine according to claim 4, characterized in that it envisages a magazine (17) for the skewers (3), which is provided with means that move it with reciprocating rectilinear motion such as to enable constant ordering of the skewers (3) both inside it and upon extraction therefrom; thus obtaining that the skewers adhere to the outer surface of the drum carrying the housings (9) and are picked up in a continuous way from the bundle that adheres to the drum itself, without any reciprocating movements.

6. The machine according to claim 1, characterized in that to enable that the change of production, i.e., the replacement of the containers/trays (2) mounted on the conveyor (1) can take place in short times, provided on the conveyor (1) are fast-coupling means for the containers/trays (2) that do not require the use of tools.

7. The machine according to claim 2, characterized in that said piercing and thrust elements, which are mobile and synchronized, are set circumferentially so as to constitute a revolver-type arrangement, wherein actuation of the pre-piercing needles (7) and of the skewering device (8) is obtained by means of an innovative desmodromic cam command (11) synchronized with the movement of the conveyor belt.

8. The machine according to claim 1, characterized in that it envisages means for closing the containers/trays (2) that are basically constituted by an endless belt (14) that moves in synchronism with the conveyor (1); said belt (14) being pressed on the conveyor and in particular on the containers/trays that contain the pieces of food to ensure a gentle grip on the piece/pieces of food, without the need for further drives and/or motor drives, given that it is moved by the friction between the belt itself and the containers (2) themselves.

9. The machine according to claim 5, characterized in that it envisages an innovative system for picking up the skewers (3), wherein the skewer magazine (17) has a fixed front wall (16), whilst the rest of the magazine, provided with an inclined bottom, is mobile with reciprocating horizontal motion obtained via a purposely provided crankshaft system (15).

10. The machine according to claim 1, characterized in that it comprises means for skewering basically constituted by:
i) a first moving element comprising a first pointed needle (7), preferably made of stainless steel, designed for pre-piercing the pieces of food;
ii) a second moving element comprising a second needle (8), preferably made of stainless steel, designed for pushing the skewer (3) into the pieces of food;
iii) means for synchronized movement by means of cams (11) of the two moving elements referred to in the previous points i) and ii);
iv) means for picking up the skewers (3) from a purposely provided magazine; and
v) means for containing the skewers (3) within respective housings (9) by means of a purposely provided flexible band (10).
